(19) United States
(12) Patent Application Publication
(10) Pub. No.: US 2025/0175678 A1
(43) Pub. Date: May 29, 2025

(54) METHOD FOR PROVIDING SERVICE USING DATACASTING BASED ON ATSC 3.0 BROADCAST ENVIRONMENT AND APPARATUS USING THE SAME

(71) Applicant: ELECTRONICS AND TELECOMMUNICATIONS RESEARCH INSTITUTE, Daejeon (KR)

(72) Inventors: Hyun-Jeong YIM, Daejeon (KR); Sung-Ik PARK, Daejeon (KR); Jae-Hyun SEO, Daejeon (KR); Nam-Ho HUR, Daejeon (KR)

(21) Appl. No.: 18/963,294

(22) Filed: Nov. 27, 2024

(30) Foreign Application Priority Data
Nov. 27, 2023 (KR) 10-2023-0166473

(51) Int. Cl. H04N 21/81; H04N 21/235

(52) U.S. Cl. CPC H04N 21/814; H04N 21/235

(57) ABSTRACT

Disclosed herein are a method for providing a service using datacasting based on an ATSC 3.0 broadcast environment and an apparatus therefor. The method includes delivering, by an apparatus for transmitting a broadcast signal based on ATSC 3.0, a Service Priority Table (SPT) and an access rule to a service platform using a broadcast signal; and determining, by the service platform, a service provision order in consideration of the service priority table and the access rule and providing, by the service platform, services according to the determined service provision order. The service platform provides various services, including a broadcast service, based on sharing of limited frequency and channel resources.

### CROSS REFERENCE TO RELATED APPLICATION

This application claims the benefit of Korean Patent Application No. 10-2023-0166473, filed Nov. 27, 2023, which is hereby incorporated by reference in its entirety into this application.

### BACKGROUND OF THE INVENTION

### 1. Technical Field

The present disclosure relates generally to technology for providing a service using datacasting based on an ATSC 3.0 broadcast environment, and more particularly to technology capable of providing broadcast services by delivering priority information and access permission information for the services when multiple services are present in a single service channel and these services are provided from different producers in an environment in which media services are transmitted and received using a broadcast network or a communication network.

### 2. Description of the Related Art

The next-generation broadcasting, including ATSC 3.0, is changing from existing one-way video/audio services to multimedia services provided in an integrated manner through various networks. As part of this change, new broadcast methods, such as ‘time sharing’ or ‘spectrum sharing’ have been discussed.

The “spectrum sharing” refers to a method in which multiple service providers adjust and optimize broadcast content in real time. The ultimate objective of the shift to this new broadcast paradigm is to provide services customized to the needs of users by sharing a limited frequency band and efficiently operating a network through optimization of resources.

### Documents of Related Art

(Patent Document 1) Korean Patent Application Publication No. 10-2021-0025241, published on Mar. 9, 2021 and titled “Apparatus for receiving broadcast signal and operation method thereof”.

### SUMMARY OF THE INVENTION

An object of the present disclosure is to provide a method of managing priority of services shared by various service providers and delivering an access rule in a next-generation broadcast environment in which limited frequency and channel resources are shared.

Another object of the present disclosure is to define data information as sub-attributes of a Service List Table (SLT) or define a Service Priority Table (SPT), thereby clearly identifying the priority of each service and delivering an access rule.

A further object of the present disclosure is to provide transmission and reception technology for efficiently providing content.

In order to accomplish the above objects, a method for providing a service using datacasting based on an ATSC 3.0 broadcast environment according to the present disclosure includes delivering, by an apparatus for transmitting a broadcast signal based on ATSC 3.0, a Service Priority Table (SPT) and an access rule to a service platform using a broadcast signal; and determining, by the service platform, a service provision order in consideration of the service priority table and the access rule and providing, by the service platform, services according to the determined service provision order. The service platform provides various services, including a broadcast service, based on sharing of limited frequency and channel resources.

Here, the service priority table may include a service priority value, a service priority description, a criterion for determining service priority, a service priority activation time, and a service priority deactivation time, and the access rule may include access permission based on the service priority.

Here, delivering the service priority table and the access rule may comprise defining the service priority table and the access rule in sub-attributes of a Service List Table (SLT) and transmitting the SLT to the service platform through Low Level Signaling (LLS).

Here, delivering the service priority table and the access rule may comprise generating a user-defined table through an extended definition of Low Level Signaling (LLS), defining the service priority table and the access rule in the user-defined table, and transmitting the user-defined table to the service platform through the LLS.

Here, the service platform may perform a priority-based datacasting service, capacity and bandwidth optimization, and a customized datacasting service for a specific user group based on the service priority table and access rule defined in a form specialized for datacasting.

Here, the service priority table and access rule defined in the form specialized for datacasting may include a target user group, a type of datacasting, a target region of datacasting, an allowed access type, and a criterion and condition for allowing access.

Also, an apparatus for transmitting a broadcast signal according to an embodiment of the present disclosure includes a processor for delivering a Service Priority Table (SPT) and an access rule to a service platform using a broadcast signal and memory for storing the service priority table and the access rule. The service platform determines a service provision order in consideration of the service priority table and the access rule, provides services according to the determined service provision order, and provides various services, including a broadcast service, based on sharing of limited frequency and channel resources.

Here, the service priority table may include a service priority value, a service priority description, a criterion for determining service priority, a service priority activation time, and a service priority deactivation time, and the access rule may include access permission based on the service priority.

Here, the processor may define the service priority table and the access rule in sub-attributes of a Service List Table (SLT) and transmit the SLT to the service platform through Low Level Signaling (LLS).

Here, the processor may generate a user-defined table through an extended definition of Low Level Signaling (LLS), define the service priority table and the access rule in the user-defined table, and transmit the user-defined table to the service platform through the LLS.

Here, the service platform may perform a priority-based datacasting service, capacity and bandwidth optimization, and a customized datacasting service for a specific user group based on the service priority table and access rule defined in a form specialized for datacasting.

Here, the service priority table and access rule defined in the form specialized for datacasting may include a target user group, a type of datacasting, a target region of datacasting, an allowed access type, and a criterion and condition for allowing access.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating an example in which a broadcaster and a Broadcast Virtual Network Operator (BVNO) provide services together and deliver the same to receivers by sharing a broadcast network;

FIG. 2 is a flowchart illustrating a method for providing a service using datacasting based on an ATSC 3.0 broadcast environment according to an embodiment of the present disclosure;

FIGS. 3 to 5 are views illustrating an example of using a Service Priority Table (SPT) in ATSC 3.0 signaling (Low Level Signaling (LLS) and Service Level Signaling (SLS)) according to the present disclosure;

FIG. 6 is a view illustrating an example of delivering an SPT and an access rule using sub-attributes of a Service List Table (SLT) according to the present disclosure;

FIG. 7 is a view illustrating an example of delivering an SPT and an access rule using a user-defined table of LLS according to the present disclosure; and

FIG. 8 is a view illustrating an apparatus for transmitting a broadcast signal according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Hereinafter, a preferred embodiment of the present disclosure will be described in detail with reference to the accompanying drawings.

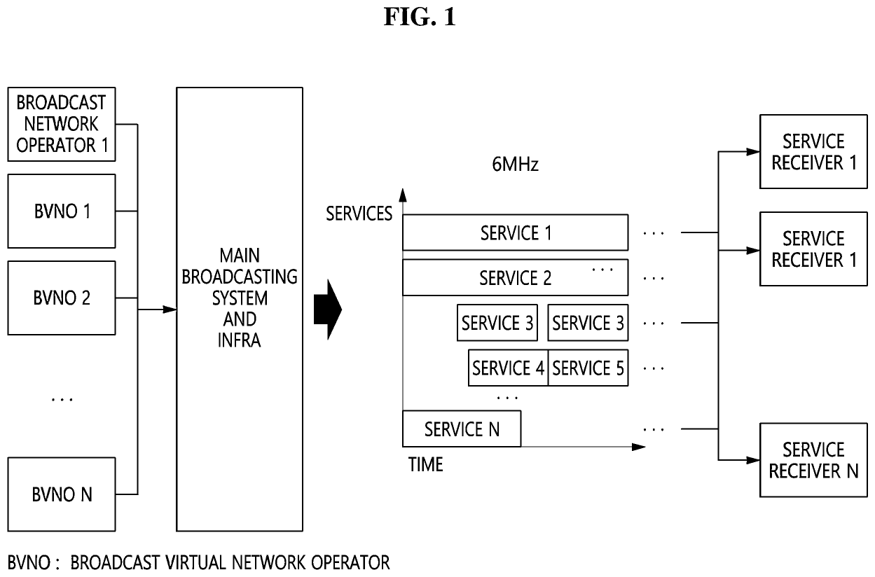

FIG. 1 is a view illustrating an example in which a broadcaster and a Broadcast Virtual Network Operator (BVNO) provide services together and deliver the same to receivers by sharing a broadcast network.

Referring to FIG. 1, with the development of ATSC 3.0, the possibility of datacasting and channel sharing through which multiple licenses are transmitted by being carried on a single 6 MHz channel is increasing. Accordingly, a broadcast spectrum will be operated in cooperation with other providers in addition to a channel operated by a broadcaster, and it is possible to transmit multiple data streams on a single channel.

Here, datacasting is technology for transmitting data by including the data in existing broadcast signals, and enables extension from a platform only for broadcasting to a platform for providing various data services. ATSC 3.0 includes core technology related to datacasting in the standard, and based thereon, datacasting may transmit data such as files and other digitized information to receivers in the form of non-TV (digital signage, connected cars, etc.) as well as TVs. Particularly, datacasting has a great advantage in that it is possible to simultaneously deliver data required by many people using a broadcast network in an environment in which it is difficult to access the Internet.

Datacasting in ATSC 3.0 may be useful in various applications, from emergency alarm messages to software updates. The main datacasting scenarios discussed in ATSC 3.0 correspond to an emergency information delivery service, education content, software updates, improved service data transmission, and the like. The emergency information delivery service corresponds to transmission of alarms, weather updates, evacuation routes, and other important information from a broadcaster to receivers in real time, and the education content corresponds to direct transmission of textbooks, teaching materials, and learning-related data from a school or the like to the receivers of students. The software updates correspond to downloading and installing software without individual Internet access by delivering data using a broadcast network in order to update functions of a specific reception terminal, and the improved service data transmission corresponds to providing additional content for a live TV show (for example, providing relevant player information, statistical information, and the like during a sports event).

The ATSC 3.0 standard includes various underlying mechanisms for datacasting and channel sharing. Representative examples include technologies such as protocol layering, service signaling, ROUTE, application signaling, service announcement, service usage reporting, and the like.

However, the current ATSC 3.0 standard does not include definite regulations related to service priority or access permission settings. Accordingly, the criteria for determining which services should be prioritized on a broadcast channel used by multiple service providers and which services should be queued are ambiguous. Also, if a specific service is not immediately accessible when the service is required at a specific time or situation, user experience may be degraded. As a result, there is a risk of degrading broadcast quality, user satisfaction, and the overall efficiency of broadcast services.

Also, each service provider will provide its service with various strategies for most effectively delivering the service. However, it is difficult to effectively reflect the strategies in the current standard. For example, when it is necessary to preferentially deliver an emergency broadcast or important news, it is difficult to ensure this with the current standard.

Therefore, the present disclosure intends to propose a method for providing information about service priority and an access rule. The core of the present disclosure is to determine and efficiently manage the optimal service provision order through cooperation between multiple service providers while optimizing user experience.

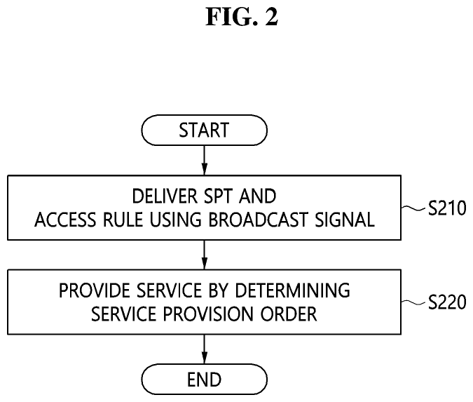

FIG. 2 is a flowchart illustrating a method for providing a service using datacasting based on an ATSC 3.0 broadcast environment according to an embodiment of the present disclosure.

Referring to FIG. 2, in the method for providing a service using datacasting based on an ATSC 3.0 broadcast environment according to an embodiment of the present disclosure, an apparatus for transmitting a broadcast signal based on ATSC 3.0 delivers a Service Priority Table (SPT) and an access rule to a service platform using a broadcast signal at step S210.

Here, service priority is priority information for a specific service or channel, and may indicate which service has priority over other services in a specific situation.

Also, the access rule may indicate permission information of a user or device that can access a specific channel or service.

In actual broadcasting, the service priority and the access rule may be determined depending on the strategy of a service provider or operator, and may vary depending on various factors, such as the importance of content, the economic value of the service, a service contract, network conditions, service use context, and the like.

Here, the service priority table and the access rule may be defined in sub-attributes of a Service List Table (SLT), and the SLT may be transmitted to the service platform through Low Level Signaling (LLS).

The Service List Table (SLT) defined in ATSC 3.0 may provide service information to users. Here, the SLT is one of tables delivered through Low Level Signaling (LLS) and contains basic information about services that is required at an upper layer. Therefore, the present disclosure proposes a method of providing the service priority and the access rule to the service platform by defining the service priority and the access rule as the elements and attributes of the SLT.

Here, the service priority table may include a service priority value, a service priority description, a criterion for determining service priority, a service priority activation time, and a service priority deactivation time, and the access rule may include access permission based on the service priority.

For example, Table 1 defines the service priority table and the access rule by extending the SLT, and it can be seen that priorityValue, priorityDescription, priorityCriterion, priority ActivationTime, priorityDeactivationTime, accessPermission, and the like are additionally defined as the sub-attributes of the Service element.

TABLE 1

| Element | Attribute | DataType | description |
|---|---|---|---|
| Service | @serviceld | unsignedShort | A field defined in the existing SLT. Indicates the |
| | | | ID of the service and uses the same data type as |
| | | | the service ID used in other parts of ATSC 3.0. |
| | @priorityValue | unsignedByte | Indicates a priority value, and the lower the |
| | | | value, the higher the priority. |
| | @priorityDescription | String | Describes a technical or semantic explanation for |
| | | | defining priority. Optional attribute. |
| | @priorityCriterion | String | Describes a criterion or reason for determining |
| | | | priority. Example: an emergency broadcast, a |
| | | | primetime show, a VIP-only service, etc. |
| | @priorityActivationTime | dateTime | Indicates the time at which priority is activated. |
| | | | After this time, the corresponding priority is |
| | | | applied. When the value is not specified, priority |
| | | | is assumed to be continuously maintained. |
| | @priorityDeactivationTime | dateTime | Indicates the time at which priority is |
| | | | deactivated. For example, when a specific |
| | | | emergency broadcast is scheduled from 3:00 to |
| | | | 5:00, the priority of the corresponding service is |
| | | | activated at 3:00 and deactivated at 5:00. |
| | @accessPemission | String | Describes service access permission based on |
| | | | priority. For example, when a specific service is |
| | | | region-restricted, it may describe information |
| | | | about a specific region, or when a service is |
| | | | provided only to VIP users, it may describe |
| | | | access permission for each level, such as |
| | | | VIP_only. |

Here, an embodiment of a schema definition for Table 1 may be represented as shown in Table 2.

TABLE 2
<?xml version=“1.0”?>
<xs:schema xmlns:xs=“http://www.w3.org/2001/XMLSchema”>
.............
<xs:element name=“ServiceListTable”>
<xs:complexType>
<xs:sequence>
<xs:element name=“Service” maxOccurs=“unbounded”>
<xs:complexType>
<xs:attribute name=“serviceId” type=“xs:unsignedShort” use=“required”/>
<xs:attribute name=“priorityValue” type=“xs:unsignedByte” use=“optional”/>
<xs:attribute name=“priorityDescription” type =“xs:string” use=“optional”/>
<xs:attribute name=“priorityCriterion” type=“xs:string” use=“optional”/>
<xs:attribute name=“priorityActivationTime” type=“xs:dateTime” use=“optional”/>
<xs:attribute name=“priorityDeactivationTime” type=“xs:dateTime” use=“optional”/>
<xs:attribute name=“accessPermission” type=“xs:boolean” use=“optional”/>
</xs:complexType>
</xs:element>
</xs:sequence>
</xs:complexType>
</xs:element>
</xs:schema>
...

Here, a user-defined table may be generated through the extended definition of Low Level Signaling (LLS), the service priority table and the access rule may be defined in the user-defined table, and the user-defined table may be transmitted to the service platform through LLS.

In the ATSC 3.0 A/331 standard, UserDefined LLS_table_id 0xFF is defined to allow the definition of LLS to be extended. Therefore, the present disclosure proposes also a method of defining a new signaling table using this in order to define the service priority table and the access rule.

For example, the service priority and the access rule are defined in a new LLS table, as shown in Table 3, and a schema therefor may be defined as shown in Table 4.

TABLE 3

| element | Attribute | DataType | description |
|---|---|---|---|
| Service | @serviceld | unsignedShort | Top element. Includes one or more ‘Service’ |
| Priority | | | elements. |
| Table | | | |
| Service | @serviceld | unsignedShort | Indicates the ID of the service and is a mandatory |
| | | | attribute. Information corresponding to Service ID |
| | | | described in the SLT. This value is used to refer to |
| | | | information about services. |
| | @priorityValue | unsignedByte | Indicates a priority value, and the lower the value, |
| | | | the higher the priority. A mandatory attribute. |
| | @priorityCriterion | String | Describes a criterion or reason for determining |
| | | | priority. Example: an emergency broadcast, a |
| | | | primetime show, a VIP-only service, etc. |
| | @priorityActivationTime | dateTime | Indicates the time at which priority is activated. |
| | | | After this time, the corresponding priority is |
| | | | applied. When the value is not specified, priority |
| | | | is assumed to be continuously maintained. |
| | @priorityDeactivationTime | dateTime | Indicates the time at which priority is deactivated. |
| | | | For example, when a specific emergency broadcast |
| | | | is scheduled from 3:00 to 5:00, the priority of the |
| | | | corresponding service is activated at 3:00 and |
| | | | deactivated at 5:00. |
| | @accessPemission | String | Describes service access permission based on |
| | | | priority. For example, when a specific service is |
| | | | region-restricted, it may describe information |
| | | | about a specific region, or when a service is |
| | | | provided only to VIP users, it may describe access |
| | | | permission for each level, such as VIP_only. |

TABLE 4
### XML Schema (XSD) for ServicePriorityTable (SPT)
‘‘‘xml
<?xml version=“1.0”?>

| | |
|---|---|
| <xs:schema | xmlns:xs=“http://www.w3.org/2001/XMLSchema” |

targetNamespace=“urn:atsc:3.0:sys:ServicePriority”
xmlns=“urn:atsc:3.0:sys:ServicePriority” element FormDefault=“qualified”>
<xs:element name=“ServicePriorityTable”>
<xs:complexType>
<xs:sequence>
<xs:element name=“Service” maxOccurs=“unbounded”>
<xs:complexType>
<xs:attribute name=“serviceId” xs:unsignedShort” use=“required”/>
<xs:attribute name=“priorityValue” type=“xs:unsignedByte” use=“required”/>
<xs:attribute name=“priorityCriterion” type=“xs:string” use=“optional”/>
<xs:attribute name=“priorityActivationTime” type=“xs:dateTime” use=“required”/>
<xs:attribute name=“priorityDeActivationTime” type=“xs:dateTime” use=“optional”/>
<xs:attribute name=“accessPermission” type=“xs:string” use=“optional”/>
</xs:complexType>
</xs:element>
</xs:sequence>
</xs:complexType>
</xs:element>
</xs:schema>
...

In this manner, it is possible to extend additional information or functionality without changing the framework of the standard.

However, when different institutions or organizations use the same LLS_table_id to define various tables as the user-defined table, which may cause an interoperability problem.

Here, Table 5 shows a use case of the service priority table written based on the description in Table 4, and serviceId 101 may represent a VIP service having the highest priority. On the other hand, serviceId 102 represents a regular broadcast having lower priority than serviceId 101. That is, serviceId 101 is for VIPs and access permission is limited to VIP users, whereas serviceId 102 is a regular broadcast and is accessible to everyone.

TABLE 5
<?xml version=“1.0”?>
<ServicePriorityTable xmlns=“urn:atsc:3.0:sys:ServicePriority”>
<Service serviceId=“101” priorityValue=“1” priorityCriterion=“VIP Service”
priorityActivationTime=“2023-08-06T10:00:00Z” accessPermission=“Full Access for
VIP”/>
<Service serviceId=“102” priorityValue=“10” priorityCriterion=“Regular Broadcast”
priorityActivationTime=“2023-08-06T11:00:00Z” priorityDeActivationTime=“2023-
08-06T12:00:00Z” accessPermission=“Open to All”/>
</ServicePriorityTable>

Also, in the method for providing a service using datacasting based on an ATSC 3.0 broadcast environment according to an embodiment of the present disclosure, the service platform determines a service provision order in consideration of the service priority table and the access rule and provides the service according to the determined service provision order at step S220.

Here, the service platform may provide various services, including a broadcast service, based on sharing of limited frequency and channel resources.

Here, the service platform may perform a priority-based datacasting service, capacity and bandwidth optimization, and a customized datacasting service for a specific user group based on the service priority table and access rule defined in a form specialized for datacasting.

Here, the service priority table and access rule defined in the form specialized for datacasting may include a target user group, the type of datacasting, the target region of datacasting, an allowed access type, and a criterion and condition for allowing access.

That is, the service priority table and the access rule may be useful when datacasting is performed. Accordingly, in order to more efficiently provide datacasting, the present disclosure defines elements and attributes for datacasting as shown in the embodiment of Table 6, thereby providing mechanisms such as provision of a priority-based datacasting service, capacity and bandwidth optimization, customized datacasting for a specific user group, and the like.

TABLE 6

| Element | Attribute | Data Type | description |
|---|---|---|---|
| ServicePriorityTable | @tableId | unsignedByte | Indicates the ID of the table, and may use 0xFF (a |
| | | | value reserved for user definition in ATSC 3.0). |
| | @version | unsignedByte | Version information of the table |
| Service | @serviceId | unsignedShort | Indicates the ID of the service and is a mandatory |
| | | | attribute. Information corresponding to Service |
| | | | ID described in the SLT. This value is used to |
| | | | refer to information about services. |
| PriorityDetails | @priorityValue | unsignedByte | Indicates a priority value, and is a mandatory |
| | | | attribute. |
| | @priorityCriterion | String | Describes a criterion or reason for determining |
| | | | priority. |
| | @priorityActivationTime | dateTime | Indicates the time at which priority is activated |
| | @priorityDeactivationTime | dateTime | Indicates the time at which priority is deactivated |
| DatacastingDetails | | | optional |
| | @targetUserGroup | | Indicates a target user group |
| | | | Examples: VIP, Regular, etc. |
| | @datacastType | | Indicates the type of datacasting |
| | | | Examples: News, Weather, Traffic, etc. |
| | @region | | Indicates a target region of datacasting |
| AccessPermission | | | optional |
| | @permissionType | String | Indicates an allowed access type |
| | | | Examples: Free, Paid, Restricted, etc. |
| | @permissionCriterion | String | Indicates a criterion or condition for allowing |
| | | | access. |

Here, when a service operator provides various types of datacasting services, the service operator may preferentially transmit a specific service or content using the priority information. For example, when there is a special service, such as a VIP service or urgent information delivery, datacasting priority of the corresponding service may be set to high.

Also, datacasting may have limited capacity within the broadcast bandwidth. Therefore, capacity and bandwidth optimization may be performed by preferentially transmitting important data or services through the service priority table and the access rule and by transmitting the rest according to the remaining bandwidth.

Also, a customized datacasting service may be provided to a specific user group or region using the priority information.

Here, the data type described as String in Table 6 is merely an embodiment and may be used differently in the future according to a specific rule.

Table 7 illustrates an example of an XML schema definition for the content defined in Table 6, and Table 8 illustrates example code written based on Table 6 and Table 7.

TABLE 7
<?xml version=“1.0”?>
<xs:schema xmlns:xs=http://www.w3.org/2001/XMLSchema>
<xs:element name=“ServicePriorityTable”>
<xs:complexType>
<xs:sequence>
<xs:element name=“Service” maxOccurs=“unbounded”>
<xs:complexType>
<xs:sequence>
<xs:element name=“PriorityDetails”>
<xs:complexType>
<xs:attribute name=“priorityValue” type=“xs:unsignedByte” use=“required”>
<xs:attribute name=“priorityCriterion” type=“xs:string” use=“required”>
<xs:attribute name=“priorityActivationTime” type=“xs:dateTime” use=“required” />
<xs:attribute name=“priorityDeactivationTime” type=“xs:dateTime” use=“optional” />
</xs:complexType>
</xs:element>
<xs:element name=“DatacastingDetails” minOccurs=“0”>
<xs:complexType>
<xs:attribute name=“targetUserGroup” type=“xs:string” use=“required”/>
<xs:attribute name=“datacastType” type=“xs:string” use=“required” />
<xs:attribute name=“region” type=“xs:string” use=“optional”/>
<xs:attribute name=“capacity” type=“xs:unsignedInt” use=“optional”/>
<xs:attribute name=“bandwidth” type=“xs:unsignedInt” use=“optional” />
</xs:complexType>
</xs:element>
<xs:element name=“AccessPermission” minOccurs=“0”>
<xs:complexType>
<xs:attribute name=“permissionType” type=“xs:string” use=“required” />
<xs:attribute name=“permissionCriterion” type=“xs:string” use=“required”/>
</xs:complexType>
</xs:element>
</xs:sequence>
<xs:attribute name=“serviceId” type=“xs:unsignedShort” use=“required” />
</xs:complexType>
</xs:element>
</xs:sequence>
<xs:attribute name=“tableId” type=“xs:unsignedByte” use=“required”/>
<xs:attribute name=“version” type=“xs:unsignedByte” use=“required”/>
</xs:complexType>
</xs:element>
</xs:schema>

TABLE 8

<ServicePriorityTable tableId=“0xFF” version=“1”>
<Service serviceId=“1001”>
<PriorityDetails
priorityValue=“1”
priorityCriterion=“Emergency”
priorityActivationTime=“2023 08 06T08:00:00”
priorityDeactivationTime=“2023 08 06T20:00:00”/>
<DatacastingDetails
targetUserGroup=“VIP”
datacastType=“Software Upgrade”
region=“Seoul”/>
<AccessPermission
permissionType=“Paid”
permissionCriterion=“Subscribed VIP Users”/>
</Service>
<Service serviceId=“1002”>
<PriorityDetails
priorityValue=“2”
priorityCriterion=“Regular”
priorityActivationTime=“2023 08 06T10:00:00”/>
<DatacastingDetails
targetUserGroup=“Regular”
datacastType=“News”/>
<AccessPermission
permissionType=“Free”
permissionCriterion=“All Users”/>
</Service>
</ServicePriorityTable>

Referring to the example code described in Table 8, the service operator may provide two datacasting services.

For example, the first service (serviceId=1001) may correspond to a software upgrade service for VIP users. This service is targeted at the Seoul region and is only accessible to the subscribed VIP users for a fee. Because the priority of this service is set to ‘Emergency’, this service may be transmitted and provided in preference to other datacasting services in the event of an emergency. Also, the priority information of this service is activated from 8 a.m. and is valid until 8 p.m.

The second service (serviceId=1002) may correspond to a news service for regular users. This service is accessible to all users for free and is an embodiment in which the priority thereof is set to ‘Regular’ and the service has been activated from 10 a.m.

That is, when priority information is defined for each service (including datacasting) through the service priority table proposed by the present disclosure, the service to be prioritized may bs selected from among multiple services provided within the 6 MHz band.

For example, when there are 50 services provided through a service platform, if priority is set for each of the services, the services may be transmitted according to the priority. A high-priority service, such as an urgent software upgrade service for VIP users, may be handled to be transmitted in preference to other regular services.

By assigning a priority value to each service as described above, it is possible to prioritize a more important or urgent service within the broadcast bandwidth and to flexibly provide services by changing the priority of the services at a specific time or according to conditions.

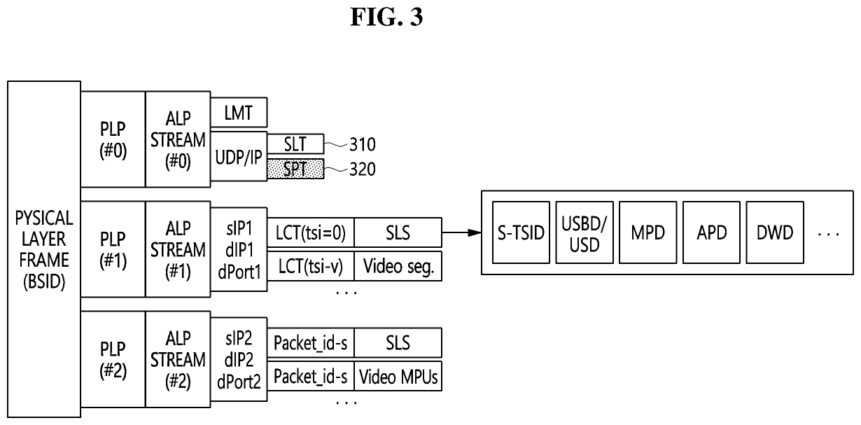

Also, referring to FIGS. 3 to 5, the present disclosure describes an example in which an SPT 320 is used as a separate table at an LLS level in a single Broadcast Stream ID (BSID) to which three Physical Layer Pipes (PLPs) belong. Accordingly, the SPT 320 proposed by the present disclosure may be used with the same concept in the transmission scenarios described in ATSC 3.0, such as a channel bonding situation, a situation of hybrid transmission combined with a broadcast network, and a situation in which a service is transmitted over one or more RF channels using other BSID.

Through the above-described method for providing a service using datacasting based on an ATSC 3.0 broadcast environment, a service provider directly sets and adjusts the priority of a desired service, thereby quickly responding to a specific broadcast situation or requirements of a user.

Also, it is possible to notify a receiver or user of transmission of an important service or data by applying the above-described method to service announcement or application signaling.

Also, the above-described method enables the actual usage of a certain service or content to be determined in connection with service usage reporting and enables the need for priority adjustment to be determined based thereon, thereby contributing to advancing datacasting technology.

Also, the above-described method enables provision of a personalized service in which a specific content or service provider provides customized information or services to a target region or group.

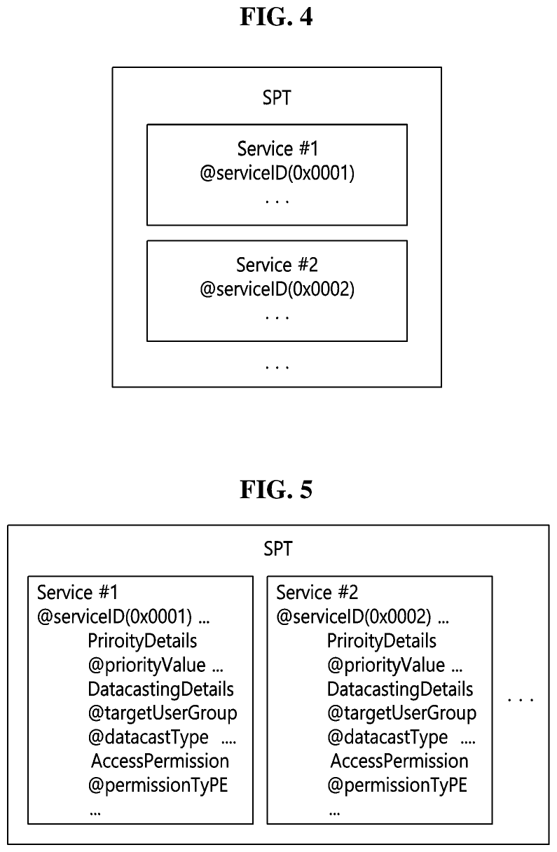

FIG. 6 is a view illustrating an example of delivering an SPT and an access rule using sub-attributes of an SLT according to the present disclosure.

Referring to FIG. 6, first, a service priority table and an access rule are defined in sub-attributes of a Service List Table (SLT) at step S610 in order to deliver the service priority table and the access rule in the present disclosure.

Subsequently, the SLT is transmitted to a service platform through Low Level Signaling (LLS) at step S620.

The Service List Table (SLT) defined in ATSC 3.0 may provide service information to users. Here, the SLT is one of tables transmitted through Low Level Signaling (LLS) and contains basic information about services that is required at an upper layer.

Accordingly, in the present disclosure, the service priority and the access rule are defined as elements and attributes of the SLT to be provided to the service platform.

Here, the service priority table may include a service priority value, a service priority description, a criterion for determining service priority, a service priority activation time, and a service priority deactivation time, and the access rule may include access permission based on the service priority.

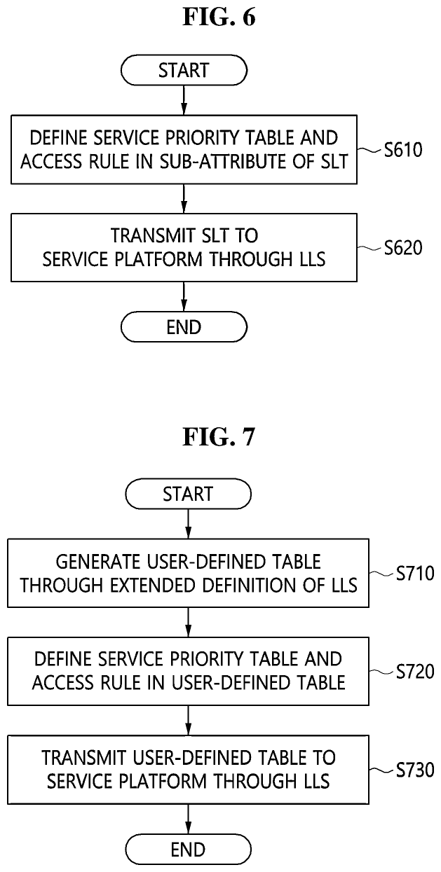

FIG. 7 is a view illustrating an example of delivering an SPT and an access rule using a user-defined table of LLS according to the present disclosure.

Referring to FIG. 7, first, a user-defined table is generated through the extended definition of Low Level Signaling (LLS) at step S710 in order to deliver a service priority table and an access rule in the present disclosure.

Subsequently, the service priority table and the access rule are defined in the user-defined table at step S720, and the user-defined table is transmitted to a service platform through LLS at step S730.

In the ATSC 3.0 A/331 standard, UserDefined LLS_table_id 0xFF is defined to allow the definition of LLS to be extended. Accordingly, a new signaling table may be defined using this in the present disclosure, and the service priority table and the access rule may be defined based thereon.

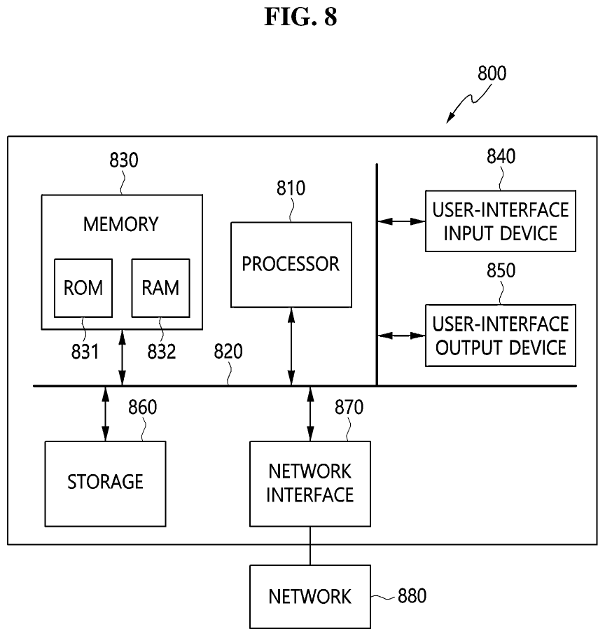

FIG. 8 is a view illustrating an apparatus for transmitting a broadcast signal according to an embodiment of the present disclosure.

Referring to FIG. 8, the apparatus for transmitting a broadcast signal according to an embodiment of the present disclosure may be implemented in a computer system including a computer-readable recording medium. As illustrated in FIG. 8, the computer system 800 may include one or more processors 810, memory 830, a user-interface input device 840, a user-interface output device 850, and storage 860, which communicate with each other via a bus 820. Also, the computer system 800 may further include a network interface 870 connected to a network 880. The processor 810 may be a central processing unit or a semiconductor device for executing processing instructions stored in the memory 830 or the storage 860. The memory 830 and the storage 860 may be any of various types of volatile or nonvolatile storage media. For example, the memory may include ROM 831 or RAM 832.

Accordingly, an embodiment of the present disclosure may be implemented as a non-transitory computer-readable medium in which methods implemented using a computer or instructions executable in a computer are recorded. When the computer-readable instructions are executed by a processor, the computer-readable instructions may perform a method according to at least one aspect of the present disclosure.

The processor 810 delivers a Service Priority Table (SPT) and an access rule to a service platform using a broadcast signal.

The memory 830 stores the service priority table and the access rule.

Here, the service platform may determine a service provision order in consideration of the service priority table and the access rule, provide services according to the determined service provision order, and provide various services, including a broadcast service, based on sharing of limited frequency and channel resources.

Here, the service priority table may include a service priority value, a service priority description, a criterion for determining service priority, a service priority activation time, and a service priority deactivation time, and the access rule may include access permission based on the service priority.

Here, the processor 810 may define the service priority table and the access rule in sub-attributes of a Service List Table (SLT) and transmit the SLT to the service platform through Low Level Signaling (LLS).

Here, the processor 810 may generate a user-defined table through the extended definition of Low Level Signaling (LLS), define the service priority table and the access rule in the user-defined table, and transmit the user-defined table to the service platform through LLS.

Here, the service platform may perform a priority-based datacasting service, capacity and bandwidth optimization, and a customized datacasting service for a specific user group based on the service priority table and access rule defined in a form specialized for datacasting.

Here, the service priority table and access rule defined in the form specialized for datacasting may include a target user group, the type of datacasting, the target region of datacasting, an allowed access type, and a criterion and condition for allowing access.

Using the above-described apparatus for transmitting a broadcast signal, a service provider directly sets and adjusts the priority of a desired service, thereby quickly responding to a specific broadcast situation or requirements of a user.

Also, through application to service announcement or application signaling, it is possible to notify a receiver or user of transmission of an important service or data.

Also, the actual usage of a certain service or content may be determined in connection with service usage reporting, and the need to adjust priority may be determined based thereon, which may contribute to advancing datacasting technology.

Also, it is possible to provide a personalized service in which a specific content or service provider provides customized information or services to a target region or a target group.

According to the present disclosure, a service provider may quickly respond to a specific broadcast situation or requirements of a user by directly setting and adjusting the priority of a desired service.

Also, the present disclosure may notify a receiver or a user of transmission of an important service or data by being applied to service announcement or application signaling.

Also, the present disclosure may contribute to advancing datacasting technology by enabling the actual usage of a certain service or content to be determined in connection with service usage reporting and enabling determination of the need for adjustment of priority based thereon.

Also, the present disclosure may provide a personalized service in which a specific content or service provider provides customized information or services to a target region or a target group.

As described above, the method for providing a service using datacasting based on an ATSC 3.0 broadcast environment and the apparatus therefor according to the present disclosure are not limitedly applied to the configurations and operations of the above-described embodiments, but all or some of the embodiments may be selectively combined and configured, so the embodiments may be modified in various ways.

What is claimed is:

1. A method for providing a service, comprising:
delivering, by an apparatus for transmitting a broadcast signal based on ATSC 3.0, a Service Priority Table (SPT) and an access rule to a service platform using a broadcast signal; and
determining, by the service platform, a service provision order in consideration of the service priority table and the access rule and providing, by the service platform, services according to the determined service provision order,
wherein the service platform provides various services, including a broadcast service, based on sharing of limited frequency and channel resources.

2. The method of claim 1, wherein
the service priority table includes a service priority value, a service priority description, a criterion for determining service priority, a service priority activation time, and a service priority deactivation time, and
the access rule includes access permission based on the service priority.

3. The method of claim 1, wherein delivering the service priority table and the access rule comprises
defining the service priority table and the access rule in sub-attributes of a Service List Table (SLT), and
transmitting the SLT to the service platform through Low Level Signaling (LLS).

4. The method of claim 1, wherein delivering the service priority table and the access rule comprises
generating a user-defined table through an extended definition of Low Level Signaling (LLS),
defining the service priority table and the access rule in the user-defined table, and
transmitting the user-defined table to the service platform through the LLS.

5. The method of claim 1, wherein the service platform performs a priority-based datacasting service, capacity and bandwidth optimization, and a customized datacasting service for a specific user group based on the service priority table and access rule defined in a form specialized for datacasting.

6. The method of claim 5, wherein the service priority table and access rule defined in the form specialized for datacasting include a target user group, a type of datacasting, a target region of datacasting, an allowed access type, and a criterion and condition for allowing access.

7. An apparatus for transmitting a broadcast signal, comprising:
a processor for delivering a Service Priority Table (SPT) and an access rule to a service platform using a broadcast signal; and
memory for storing the service priority table and the access rule,
wherein the service platform determines a service provision order in consideration of the service priority table and the access rule, provides services according to the determined service provision order, and provides various services, including a broadcast service, based on sharing of limited frequency and channel resources.

8. The apparatus of claim 7, wherein
the service priority table includes a service priority value, a service priority description, a criterion for determining service priority, a service priority activation time, and a service priority deactivation time, and
the access rule includes access permission based on the service priority.

9. The apparatus of claim 7, wherein the processor defines the service priority table and the access rule in sub-attributes of a Service List Table (SLT) and transmits the SLT to the service platform through Low Level Signaling (LLS).

10. The apparatus of claim 7, wherein the processor generates a user-defined table through an extended definition of Low Level Signaling (LLS), defines the service priority table and the access rule in the user-defined table, and transmits the user-defined table to the service platform through the LLS.

11. The apparatus of claim 7, wherein the service platform performs a priority-based datacasting service, capacity and bandwidth optimization, and a customized datacasting service for a specific user group based on the service priority table and access rule defined in a form specialized for datacasting.

12. The apparatus of claim 11, wherein the service priority table and access rule defined in the form specialized for datacasting include a target user group, a type of datacasting, a target region of datacasting, an allowed access type, and a criterion and condition for allowing access.
